(19) United States
(12) Patent Application Publication
(10) Pub. No.: US 2006/0081109 A1
(43) Pub. Date: Apr. 20, 2006

(54) Guitar pick

(76) Inventor: Jeffrey S. James, Jamestown, NY (US)

Correspondence Address: The Bilicki Law Firm, P.C., 1285 North Main Street, Jamestown, NY, 14701, US

(21) Appl. No.: 10/969,135

(22) Filed: Oct. 19, 2004

(51) Int. Cl. G10D 3/16

(52) U.S. Cl. 84/322

(57) ABSTRACT

A musician's plectrum having a top and a bottom surface, a first groove on the top surface which runs perpendicular to an axis of symmetry and positioned the user's thumb perpendicular to the axis of symmetry, and a second groove on the bottom surface which runs parallel to the axis of symmetry and positions the user's forefinger parallel to the axis of symmetry, is described. In alternate embodiments, the plectrum can further include a textured surface, a grip support, a beveled striking surface, and/or a wear-resistant coating.

### FIELD OF INVENTION

This invention relates generally to a device used to pluck stringed-instruments. More specifically, the present invention relates to a hand held pick, otherwise known as a plectrum. More in particular, the invention relates to a generally teardrop-shaped structure encompassing grooves to accommodate the musician's thumb and forefinger.

### BRIEF DESCRIPTION OF THE DRAWINGS

FIG. 1 is a top view of one embodiment of the invention.

FIG. 2 is a bottom view of one embodiment of the invention.

FIG. 3 is a top perspective view of one embodiment of the invention.

FIG. 4 is a bottom perspective view of one embodiment of the invention.

FIG. 5 is a perspective view of an embodiment showing the pick portion.

FIG. 6a is a perspective view of one embodiment of the invention.

FIG. 6b shows a view of one embodiment being held by a user.

FIG. 6c shows a perspective view of one embodiment of the invention.

### DETAILED DESCRIPTION OF EMBODIMENTS OF THE INVENTION

While the device is susceptible to various alternative forms and modifications, specific embodiments will be shown by way of example in the drawings and will be described herein in detail. However, it should be understood that the invention is not intended to be limited to the particular embodiments disclosed. Rather, it is intended that the invention covers all modifications, equivalents, and alternatives following within the spirit and scope of the invention as defined by the claims.

Furthermore, with reference to the drawings, the reader should understand that like reference numerals in different drawings refer to the like elements and components of the invention. Moreover, it should be noted that every possible alternate embodiment of the invention is not depicted by the figures.

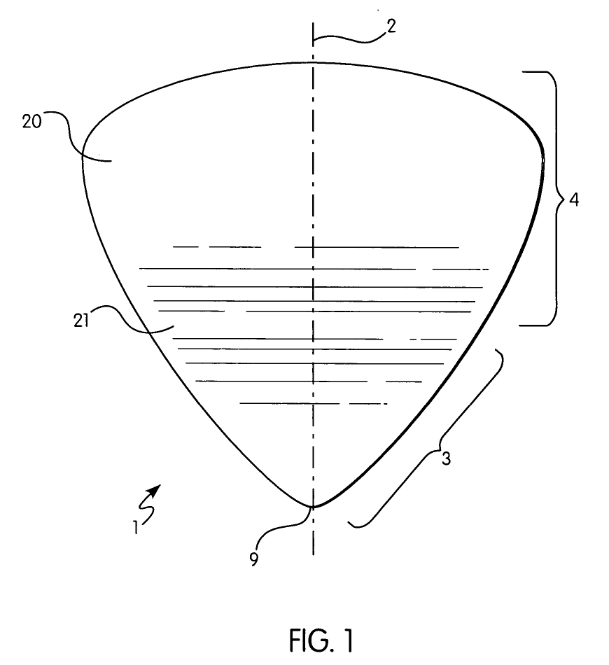

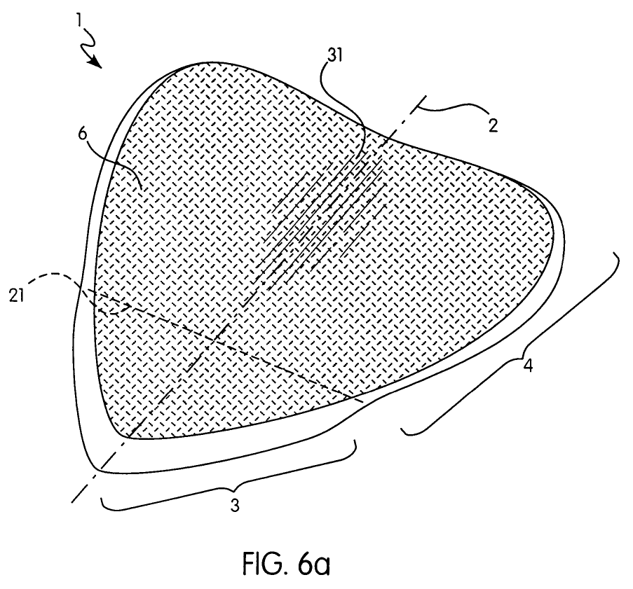

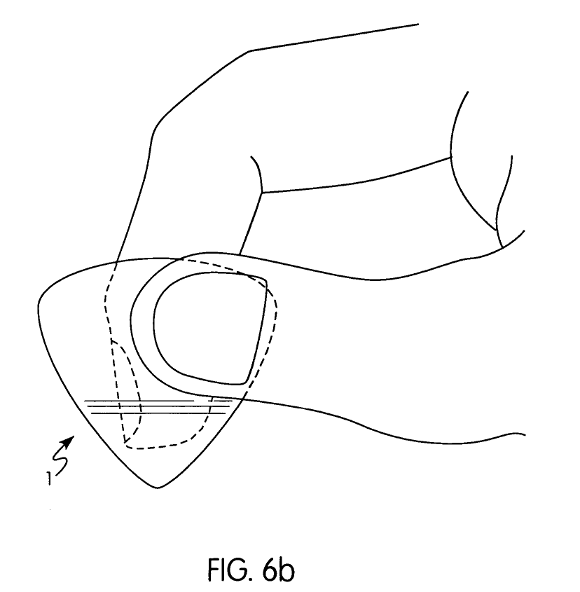

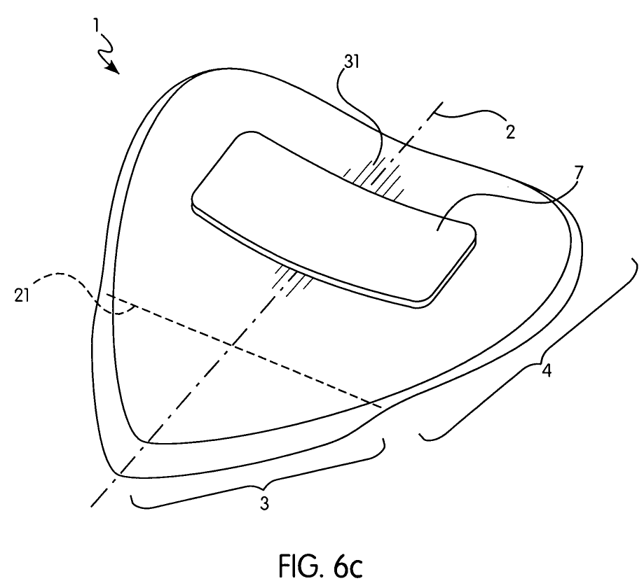

FIG. 1 is a top view of one embodiment of the invention. FIG. 1 shows top surface 20 of plectrum 1. Plectrum 1 is generally teardrop, or substantially triangular, in shape and can be divided into two approximately mirror images by axis of symmetry 2 running from tip 9 of plectrum 1 to the opposing end. Plectrum 1 is generally comprised of picking portion 3 and gripping portion 4. In the embodiment shown, picking portion 3 extends from tip 9 to approximately one third along the length of axis of symmetry 2 and is used to contact a stringed instrument (not shown). Picking portion 3 is generally triangular in shape. In the embodiment shown, gripping portion 4 extends from picking portion 3 to the back edge of plectrum 1 opposite of picking portion 3 and is approximately two thirds the length of plectrum 1 along axis of symmetry 2. Gripping portion 4 is held by the user of plectrum 1. It is understood that picking portion 3 and gripping portion 4 can be of any size or shape, as long as each can function in their designated capacities. In the embodiment shown in FIG. 1, gripping portion 4 is generally defined by four edges and forms a shape that is generally a trapezoid. Three outer edges of plectrum 1 define the outer borders, and the final edge, in this embodiment, is adjacent to an upper edge of picking portion 3 opposite of tip 9. Present on top surface 20 is first groove 21. First groove 21 is generally perpendicular to axis of symmetry 2. First groove 21 accommodates the user's thumb and orients the user's thumb generally perpendicular to the axis of symmetry (as can be seen in FIG. 6b). In the embodiment shown in FIG. 1, first groove 21 overlaps regions of both picking portion 3 and gripping portion 4. However, one skilled in the art will realize that size and position of groove 21 will dictate how much of groove 21 will be considered a component of picking portion 3 and/or gripping portion 4.

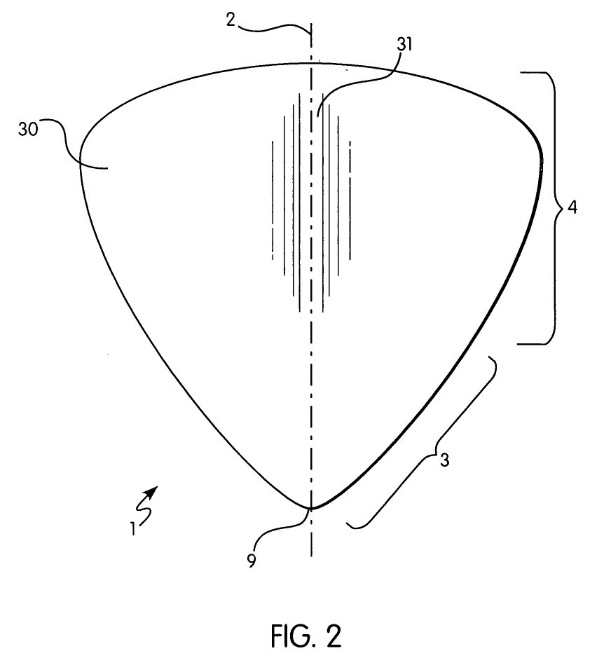

FIG. 2 is a bottom view of an embodiment of the invention. FIG. 2 shows bottom surface 30 of plectrum 1. Axis of symmetry 2, picking portion 3, and gripping portion 4 can also be observed in the figure. Additionally, second groove 31 can be seen on bottom surface 30. Second groove 31 generally follows axis of symmetry 2 of plectrum 1. In the embodiment shown in FIG. 2, second groove 31 traverses plectrum 1 from picking portion 3 through gripping portion 4.

First groove 21 on top surface 20 and second groove 31 on bottom surface 30 form gripping portion 4. In the embodiment shown in FIGS. 1 and 2, groove 21 and groove 31 are perpendicular. The positioning of first groove 21 in relationship to second groove 31 allows a user to position their thumb and forefinger on plectrum 1 such that the user's thumb runs generally parallel with first groove 21 and with the user's forefinger running generally perpendicular to the user's thumb (See FIG. 6b). Grooves 21 and 31 are generally of the shape of a hyperbolic parabola, although it is understood that any shape that will position the user's thumb and forefinger as described herein relative to plectrum may be utilized.

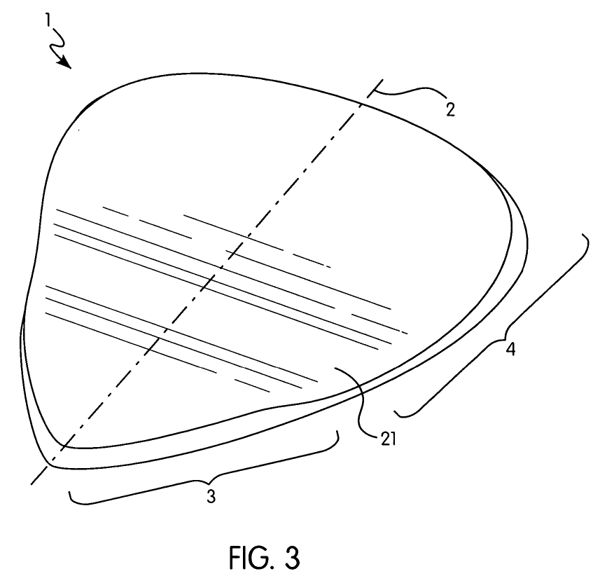

FIG. 3 is a top perspective view of one embodiment of the invention. First groove 21 can clearly be seen in the junction of picking portion 3 and gripping portion 4. As stated supra, first groove 21 accommodates a user's thumb. Therefore, the diameter of groove 21 can be modified to fit a specific user's thumb measurement or can be of a size to fit a typical adult, child, male or female.

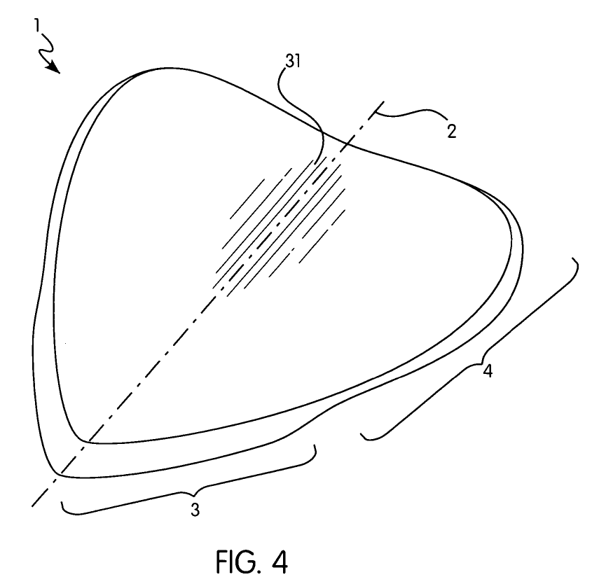

FIG. 4 is a bottom perspective view of one embodiment of the invention. In this embodiment, second groove 31 can be seen traversing gripping portion 4. That is, second groove 31 is substantially parallel to axis of symmetry 2 and runs from outer edge of plectrum 1 to the border of picking portion 3. In an alternate embodiment (not shown) second groove 31 follows axis of symmetry 2 along the entire length of plectrum 1. One skilled in the art will realize that second groove 31 can be any length of plectrum 1 as long as second groove 31 can accommodate a user's forefinger. Therefore, as with first groove 21, the diameter of second groove 31 can be modified to fit a specific or general user's forefinger measurement.

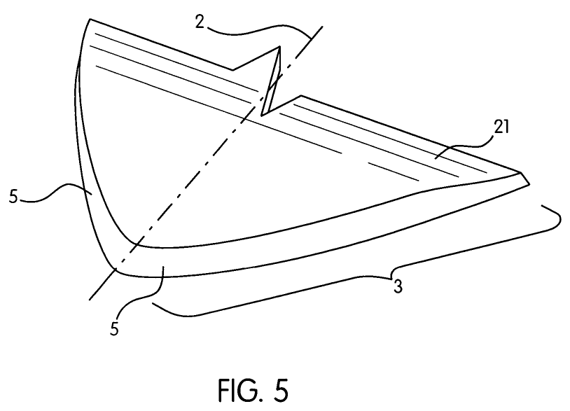

FIG. 5 shows an additional embodiment of picking portion 3. In this embodiment, picking portion 3 is configured so that an identical striking surface is obtained for right-handed users and left-handed users. Specifically, picking portion 3 has striking surfaces 5. Striking surfaces 5 are beveled on either side to accommodate a left-handed user in addition to a right-handed user. In an alternate embodiment, striking surface 5 may have a wear resistant coating to further add durability to the pick. Examples of such resistant coating, and not to be interpreted as limitations, are a ceramic, resin, metal, fiberglass, and a composite of any possible combinations thereof. In another embodiment (not shown), picking portion 3 is made with a different thickness and/or rigidity. This is done to accommodate different picking styles and results in tones different from the embodiments described herein. Of course one skilled in the art would realize that this modification or any modification to the picking portion 3 would have corresponding affects on gripping portion 4. In one embodiment, plectrum 1 is made from plastic. However, it is understood that any material that allows the user to hold plectrum 1 and use it to strike the strings of a stringed instrument may be used. Examples of such other materials, and not to be interpreted as limitations, are metal, wood, ceramic, fiberglass, a resin compound, and a composite of any possible combinations thereof.

FIG. 6a shows an additional embodiment of plectrum 1. In this embodiment, orientation of groove 21 to groove 31 is substantially perpendicular to each other. This configuration orientates the user's fingers and hand in the position visible in FIG. 6b. Additionally, this configuration allows the user to comfortably hold plectrum 1, resulting in less fatigue to the user. Also shown in the embodiment represented in FIG. 6a is textured surface 6. Textured surface 6 can be found on the entire surface of plectrum 1 or in an alternate embodiment cover portions of plectrum 1, such as only on gripping portion 4. Textured surface 6 can be part of the original mold conferring any pattern that reduces the chance of slippage by the user of plectrum 1. In addition, textured surface 6 can be a separate layer applied to plectrum 1. Examples of such other materials, not to be interpreted as limitations, are metal, wood, ceramic, fiberglass, a resin compound, rubber, and a composite of any possible combinations thereof.

FIG. 6c shows an embodiment in which additional comfort is provided for the user by adding pads 7 in gripping surface area. Pads 7 can be made of any material that is soft and provides support. Examples of such material are plastics, rubber coating, foam cushioning, fabric, gel filled containers and any material that is soft to the touch or any combination thereof.

Although the present invention has been described primarily with respect to a finite number of embodiments, it will be apparent to those of ordinary skill in the art that the invention also applies to many variations without departing from the spirit and scope of the invention.

What I claim is:

1. A plectrum comprising;
a top surface;
a bottom surface,
a first groove disposed on said top surface, wherein said first groove is substantially perpendicular to an axis of symmetry of said plectrum and positions a user's thumb substantially perpendicular to said axis of symmetry; and
a second groove disposed on said bottom surface, wherein said second groove is substantially perpendicular to said first groove and positions a user's forefinger parallel to said axis of symmetry.

2. The device of claim 1, wherein said plectrum is made of a material selected from a group comprising a plastic, a metal, a wood, a fiberglass, a resin compound, and combinations thereof.

3. The device of claim 1, wherein said first groove forms a substantially hyperbolic parabola.

4. The device of claim 1, wherein said second groove forms a substantially hyperbolic parabola.

5. The device of claim 1, wherein said top surface and said bottom surface are further comprised of a textured surface.

6. The device of claim 1, wherein the said plectrum is further comprised of a picking portion, said picking portion is beveled.

7. A device for use with a stringed instrument comprising;
a picking portion, wherein said picking portion is substantially triangular in shape;
a gripping portion, wherein said gripping portion is adjacent to said picking portion and is substantially trapezoidal in shape;
a top surface and a bottom surface, wherein said top surface and said bottom surface each traverse said picking portion and said gripping portion;
a first groove disposed on said top surface, wherein said first groove is substantially perpendicular to an axis of symmetry and positions a user's thumb substantially perpendicular to said axis of symmetry; and
a second groove disposed on said bottom surface, wherein said second groove is substantially perpendicular to said first groove and positions a user's forefinger parallel to said axis of symmetry.

8. The device of claim 7, wherein said device is made of a material selected from a group comprised of a plastic, a metal, a wood, a fiberglass, a resin compound, and combinations thereof.

9. The device of claims 7, wherein said first groove and said second groove are each in the shape of a hyperbolic parabola.

10. The device of claim 7, wherein said top surface is further comprised of a textured surface.

11. The device of claim 7, wherein said bottom surface is further comprised of a textured surface.

12. The device of claim 7, wherein said gripping portion contains a cushioning device selected from a group comprised of a plastic, a foam, a fabric, at least one gel-filled container, and combinations thereof.

13. The device of claim 7, wherein said picking portion is beveled to accommodate a right-handed user or left-handed user.

14. A plectrum comprised of a top surface and a bottom surface, said plectrum further comprising;
a gripping portion;
a picking portion;
a first groove disposed on a top surface of said plectrum and oriented generally perpendicular to an axis of symmetry and positions a user's thumb substantially perpendicular to said axis of symmetry; and
a second groove disposed on a bottom surface of said plectrum and oriented generally parallel to said axis of symmetry and positions a user's forefinger parallel to said axis of symmetry.

15. The device of claim 14, wherein said plectrum is made of a material selected from a group consisting of a plastic, a metal, a wood, a fiberglass, a resin compound, and a combination thereof.

16. The device of claim 14, wherein said first groove and said second groove are each in the form of a hyperbolic parabola.

17. The device of claim 14, wherein said top surface and said bottom surface has a textured surface.

18. The device of claim 14, wherein said gripping portion contains a cushioning device selected from a group consisting of plastic, foam, fabric, at least one gel-filled containers, and combinations thereof.

19. The device of claim 14, wherein said picking portion is beveled to accommodate a right-handed and left-handed user.

20. The device of claim 14, wherein said beveled picking portion further includes a wear resistant coating.
